(19) United States
(12) Patent Application Publication
(10) Pub. No.: US 2013/0227064 A1
(43) Pub. Date: Aug. 29, 2013

(54) MANAGEMENT DEVICE, COMPUTER-READABLE STORAGE MEDIUM STORING COMPUTER-READABLE INSTRUCTIONS AND ASSOCIATED METHOD

(71) Applicant: Tomomi SHIRAKI, Nagoya-shi (JP)

(72) Inventor: Tomomi SHIRAKI, Nagoya-shi (JP)

(73) Assignee: BROTHER KOGYO KABUSHIKI KAISHA, Nagoya-shi (JP)

(21) Appl. No.: 13/775,905

(22) Filed: Feb. 25, 2013

(30) Foreign Application Priority Data
Feb. 29, 2012 (JP) 2012-043838

(51) Int. Cl. H04L 29/08

(52) U.S. Cl. CPC H04L 67/10
USPC 709/217

(57) ABSTRACT

A management device may determine, with reference to a table, whether target information to be obtained, from a target device, corresponding to a target ID is index information. The management device may transmit a first main request including Ma-combined IDs to the target device when the target information is the index information. Each of the Ma- combined IDs may be a combination of the target ID and one of Ma- consecutive index values. The management device may determine whether Ma- partial target information corresponding to the Ma- combined IDs cannot be obtained. When the Ma-partial target information cannot be obtained, the management device may transmit a sub-request to the target device. The sub-request may comprise N- combined IDs forming a subset of the Ma- combined IDs in the first main request. N may be an integer that is 1 or greater and may be smaller than Ma.

### CROSS-REFERENCE TO RELATED APPLICATION

This application claims priority from Japanese Patent Application No. 2012-043838, filed on Feb. 29, 2012, which is incorporated herein by reference.

### TECHNICAL FIELD

Aspects of the disclosure relate to a management device that manages a target device. In addition, aspects of the disclosure relate to a computer-readable storage medium storing computer-readable instructions that manage a target device. Further, aspects of the disclosure relate to a method that manages a target device.

### BACKGROUND

In a known technique, for example, a plurality of pieces of information are obtained from a device at once by which a GETNEXT request or a GETBULK request including object identifiers (“OIDs”) for obtaining the plurality of pieces of information is transmitted.

### SUMMARY

Aspects of the disclosure provide for a technique for obtaining target information efficiently by using a different technique from the known technique, and more particularly, a technique for obtaining each partial target information efficiently when the target information includes a plurality of pieces of partial target information corresponding to a plurality of index values.

According to one or more aspects of the disclosure, a management device may comprise: a processor; and a memory storing computer-readable instructions. The computer-readable instructions, when executed by the processor, may cause the management device to perform: determining, with reference to a table, whether target information to be obtained, from a target device, corresponding to a target ID is index information including a plurality of pieces of partial information corresponding to a plurality of index values; transmitting a first main request including an Ma number of combined IDs to the target device after it is determined that the target information is the index information, wherein Ma is an integer of 2 or greater, and each of the Ma number of combined IDs is a combination of the target ID and one of Ma number of consecutive index values; determining whether Ma pieces of partial target information corresponding to the Ma number of combined IDs cannot be obtained as a consequence of the transmission of the first main request; and after it is determined that the Ma pieces of partial target information corresponding to the Ma number of combined IDs cannot be obtained as a consequence of the transmission of the first main request, transmitting a sub-request to the target device, wherein the sub-request comprises an N number of combined IDs forming a subset of the Ma number of combined IDs in the first main request, and wherein N is an integer that is 1 or greater and is smaller than Ma.

According to one or more aspects of the disclosure, a computer-readable storage medium may store computer-readable instructions. The computer-readable instructions, when executed, may cause a processor to perform: determining, with reference to a table, whether target information to be obtained, from a target device, corresponding to a target ID is index information including a plurality of pieces of partial information corresponding to a plurality of index values; transmitting a first main request including an Ma number of combined IDs to the target device after it is determined that the target information is the index information, wherein Ma is an integer of 2 or greater, and each of the Ma number of combined IDs is a combination of the target ID and one of Ma number of consecutive index values; determining whether Ma pieces of partial target information corresponding to the Ma number of combined IDs cannot be obtained as a consequence of the transmission of the first main request; and after it is determined that the Ma pieces of partial target information corresponding to the Ma number of combined IDs cannot be obtained as a consequence of the transmission of the first main request, transmitting a sub-request to the target device, wherein the sub-request comprises an N number of combined IDs forming a subset of the Ma number of combined IDs in the first main request, and wherein N is an integer that is 1 or greater and is smaller than Ma.

According to one or more aspects of the disclosure, a method may comprises: determining by a computer, with reference to a table, whether target information to be obtained, from a target device, corresponding to a target ID is index information including a plurality of pieces of partial information corresponding to a plurality of index values; transmitting, by the computer, a first main request including an Ma number of combined IDs to the target device after it is determined that the target information is the index information, wherein Ma is an integer of 2 or greater, and each of the Ma number of combined IDs is a combination of the target ID and one of Ma number of consecutive index values; determining, by the computer, whether Ma pieces of partial target information corresponding to the Ma number of combined IDs cannot be obtained as a consequence of the transmission of the first main request; and after it is determined that the Ma pieces of partial target information corresponding to the Ma number of combined IDs cannot be obtained as a consequence of the transmission of the first main request, transmitting by the computer a sub-request to the target device, wherein the sub-request comprises an N number of combined IDs forming a subset of the Ma number of combined IDs in the first main request, and wherein N is an integer that is 1 or greater and is smaller than Ma.

Other objects, features, and advantages will be apparent to persons of ordinary skill in the art from the following detailed description of the disclosure and the accompanying drawings.

### BRIEF DESCRIPTION OF THE DRAWINGS

For a more complete understanding of the present disclosure, and various objects, features, and advantages thereof, reference now is made to the following descriptions taken in connection with the accompanying drawing.

FIG. 1 depicts a configuration of a management system in an illustrative embodiment according to one or more aspects of the disclosure.

FIG. 2 is a flowchart depicting a management process performed by a management device in an illustrative embodiment according to one or more aspects of the disclosure.

FIG. 3 is a flowchart depicting a one-dimensional index information obtaining process in an illustrative embodiment according to one or more aspects of the disclosure.

FIG. 4 is a sequence diagram depicting an example of obtaining non-index information and one-dimensional index information in an illustrative embodiment according to one or more aspects of the disclosure.

FIG. 5 is a flowchart depicting a two-dimensional index information obtaining process in an illustrative embodiment according to one or more aspects of the disclosure.

FIG. 6 is a sequence diagram depicting an example of obtaining two-dimensional index information in an illustrative embodiment according to one or more aspects of the disclosure.

FIG. 7 is a flowchart depicting a K-dimensional index information obtaining process (“K” represents an integer of 3 or greater) in an illustrative embodiment according to one or more aspects of the disclosure.

FIG. 8 is a sequence diagram depicting an example of obtaining three-dimensional index information in an illustrative embodiment according to one or more aspects of the disclosure.

### DETAILED DESCRIPTION OF EMBODIMENT

(System Configuration)

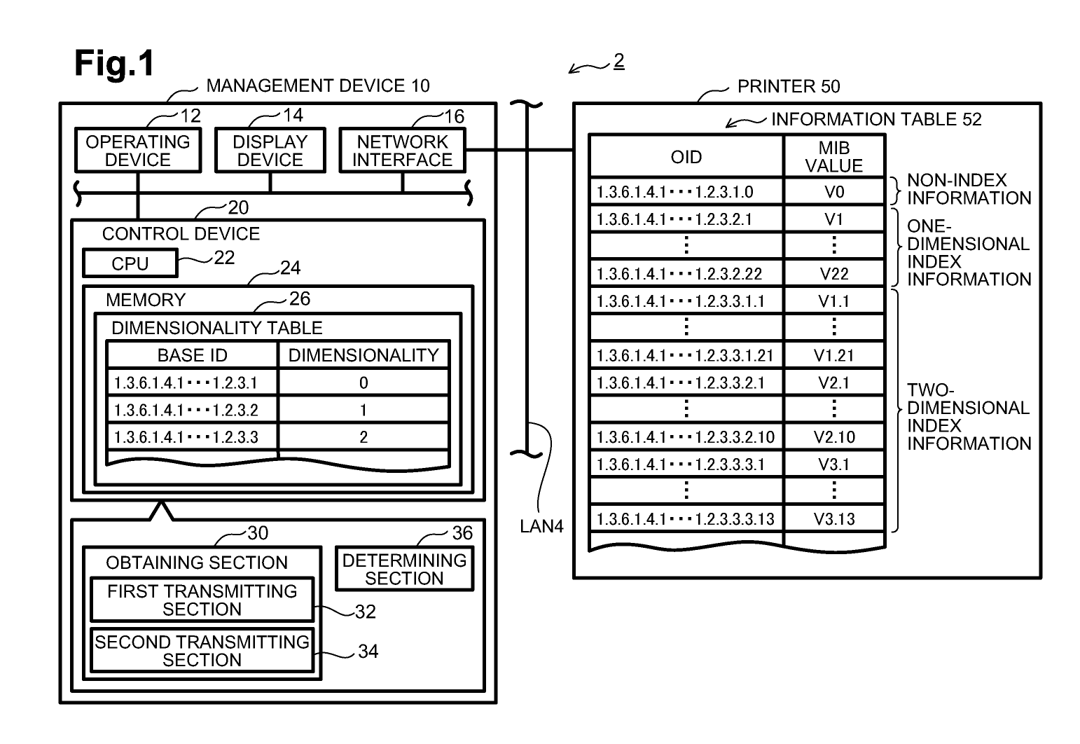

As depicted in FIG. 1, a management system 2 comprises a management device 10 and a printer 50. Although the management system 2 comprises a single printer 50 in FIG. 1, the management system 2 may comprises a plurality of printers 50. The management device 10 and the printer 50 are connected to a local-area network (“LAN”) 4. Therefore, the management device 10 and the printer 50 are configured to communicate with each other via the LAN 4.

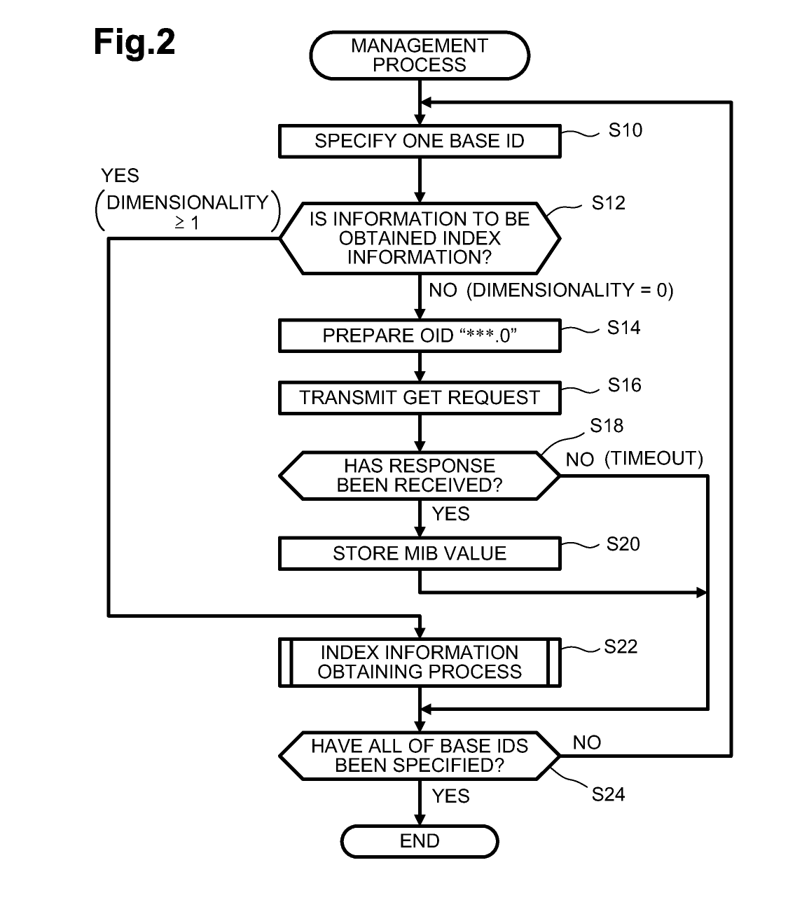

The management device 10 is, for example, a personal computer (“PC”) or a server. The management device 10 is configured to obtain various information from the printer 50 and to perform a management process (see FIG. 2) for displaying the obtained information. By doing so, the management device 10 manages the target printer 50. In this example, the management device 10 and the printer 50 are configured to perform data communications therebetween in accordance with the Simple Network Management Protocol (“SNMP”). That is, the management device 10 functions as an SNMP manager and the printer 50 functions as an SNMP agent.

(Configuration of Management Device 10)

The management device 10 comprises an operating device 12, a display device 14, a network interface (“I/F”) 16, and a control device 20. The operating device 12 comprises a keyboard and a mouse. A user is allowed to input various instructions into the management device 10 by operating the operating device 12. The display device 14 comprises a display for displaying various information thereon. The network interface 16 is configured to be connected to the LAN 4.

The control device 20 comprises a central-processing unit (“CPU”) 22 and a memory 24. The CPU 22 is configured to perform various processes in accordance with programs stored in the memory 24. The programs stored in the memory 24 comprise a management program for performing the management process. In an illustrative embodiment, the management program complies with the Simple Network Management Protocol version 1 (“SNMPv1”). In other embodiments, for example, the management program may comply with SNMP version 2 (“SNMPv2”) or SNMP version 3 (“SNMPv3”).

The management program is supplied, for example, by a vendor of the printer 50. The management program is, for example, stored in a medium shipped together with the printer 50. The user installs the management program on a device, e.g., a PC, from the medium. By doing so, the management device 10 configured to perform the management process is implemented. In other embodiments, for example, the user may install the management program on a device, e.g., the PC, by downloading the management program from a server offered by the vendor of the printer 50.

Each function of an obtaining section 30 and a determining section 36 is implemented by the performance of each process by the CPU 22 in accordance with the management program. The obtaining section 30 comprises a first transmitting section 32 and a second transmitting section 34. The management program comprises a dimensionality table 26. Therefore, in accordance with the installation of the management program on the management device 10, the dimensionality table 26 is stored in the memory 24. The dimensionality table 26 will be further described in detail below.

(Configuration of Printer 50)

The printer 50 is configured to perform printing upon receipt of a print instruction from a device (not depicted), e.g., the PC. The printer 50 stores an information table 52. The information table 52 comprises object identifiers (“OIDs”) and management information base (“MIB”) values that are associated with each other, respectively.

(MID and OID)

The printer 50 is configured to store various information in a tree structure (i.e., a hierarchy). The information to be stored in the printer 50 comprises, for example, an error history of the printer 50, a status of the printer 50 (e.g., printing or standby), setting values related to the user (e.g., a password), setting values related to printing (e.g., a default print resolution). The tree-structured information base is referred to as the “MIB”.

In the MIB hierarchy, a conception of an object is used and a number is assigned to each object. In this example, it is assumed that there are a first object (e.g., a number “1”), a second object (e.g., a number “3”), a third object (e.g., a number “6”), . . . , and a lowermost object (e.g., a number “1”) from uppermost level to lowermost level. Hereinafter, “ . . . ” represents the omission of something (e.g., one or more objects). In this case, a path for identifying information corresponding to the lowermost object is represented by “1.3.6 . . . 1”. In an illustrative embodiment, the path identified in accordance with the MIB hierarchy is referred to as a “base identifier (“ID”)”. Information corresponding to a base ID is referred to as “a piece of information”.

In the MIB hierarchy, when a piece of information corresponding to a base ID comprises a plurality of pieces of partial information, an index value is used to identify each partial information. For example, when a piece of information corresponding to the base ID “1.3.6 . . . 0.1” comprises first and second partial information, an index value “1” may be assigned to the first partial information and an index value “2” may be assigned to the second partial information. In this case, an ID corresponding to the first partial information is represented by “1.3.6 . . . 1.1” that is a combination of the base ID “1.3.6 . . . 1” and the index value “1”. Similarly, an ID corresponding to the second partial information is represented by a combination “1.3.6 . . . 1.2” of the base ID “1.3.6 . . . 1” and the index value “2”. In an illustrative embodiment, the combined ID of the base ID and the index value is also referred to as the “OID”, and the partial information corresponding to the OID is referred to as the “MIB value”. A piece of information including a plurality of pieces of partial information (i.e., a plurality of MIB values) is referred to as “index information”.

For example, it is assumed that index information corresponding to the base ID “1.3.6 . . . 0.1” represents an error history of the printer 50. When a first error occurs, the printer 50 is configured to store a value representing the error, as a MIB value corresponding to an OID “1.3.6 . . . 1.1” including an index value “1”. When a second error occurs, the printer 50 is configured to store a value representing the error, as a MIB value corresponding to an OID “1.3.6 . . . 1.2” including an index value “2”. As described above, the printer 50 is configured to store a plurality of MIB values accumulatively in association with a base ID by using the index information.

In addition, when, for example, a piece of information corresponding to the base ID “1.3.6 . . . 1” does not comprise a plurality of pieces of partial information (i.e., when the information is represented by a single value), an ID corresponding to the information is represented by “1.3.6 . . . 1.0” that is a combination of the base ID “1.3.6 . . . 1” and a default value “0”. In an illustrative embodiment, the combined ID of the base ID and the default value is also referred to as the “OID”. A piece of information not including a plurality of pieces of partial information is referred to as “non-index information”.

The printer 50 stores the non-index information and the index information in the information table 52 in association with respective OIDs. For example, a piece of information corresponding to a base ID “1.3.6.1.4.1 . . . 1.2.3.1” is non-index information including a MIB value “V0” solely (see FIG. 1). Therefore, in the information table 52, an OID “1.3.6.1.4.1 . . . 1.2.3.1.0” and the MIB value “V0” are associated with each other.

A piece of information corresponding to a base ID “1.3.6.1.4.1 . . . 1.2.3.2” is index information including 22 MIB values “V1”-“V22” corresponding to 22 index values “1”-“22” (see FIG. 1). Therefore, in the information table 52, OIDs “1.3.6.1.4.1 . . . 1.2.3.2.1”-“1.3.6.1.4.1 . . . 1.2.3.2.22” are associated with the 22 MIB values “V1”-“V22”, respectively. The 22 index values “1”-“22” are one-dimensional values (i.e., one-dimensional integers).

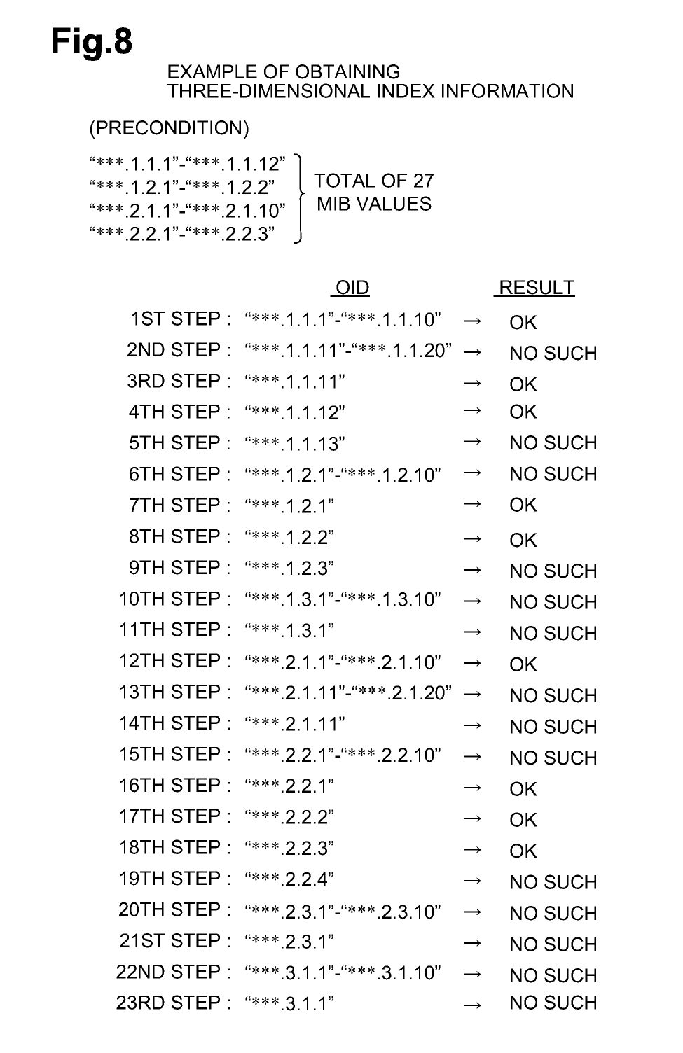

The index value may be represented by two- or more-dimensional value. For example, a piece of information corresponding to a base ID “1.3.6.1.4.1 . . . 1.2.3.3” is index information including 44 MIB values “V1.1”-“V1.21”, “V2.1”-“V2.10”, and “V3.1”-“V3.13” corresponding to 44 two-dimensional index values “1.1”-“1.21”, “2.1”-“2.10”, and “3.1”-“3.13” (see FIG. 1). Similarly, three-dimensional index values (see “1.1.1” in FIG. 8) and four-dimensional index values may be adopted. Hereinafter, the words “one-dimensional index information” and “two-dimensional index information” are also used in accordance with the dimensionality of the index value.

For example, the printer 50 may be configured to use two-dimensional index information as described below. It is assumed that the printer 50 is shared among a plurality of users. In this case, the printer 50 assigns a higher-digit value of the two-dimensional index value (e.g., the value “2” of the index value “2.3”) to each user. The printer 50 further assigns a lower-digit value of the two-dimensional index value (e.g., the value “3” of the index value “2.3”) to each user's information (e.g., a user name, or a password). Therefore, the printer 50 is configured to store each information related to the users by using the two-dimensional index information on a user basis.

In an illustrative embodiment, consecutive values (integers) are used as index values. That is, in a plurality of one-dimensional index values, the smallest value is “1” and the value is consecutively incremented by one, e.g., “2”, “3”, and so on. In a plurality of two-dimensional index values, the smallest value is “1.1” and a lower-digit value is consecutively incremented by one, e.g., “1.2”, “1.3”, and so on. A higher-digit value is also consecutively incremented by one, e.g., “1.1”, “2.1”, “3.1”, and so on. Similarly, in a plurality of three- or more-dimensional index values, consecutive values are used.

In one example, vendor of the printer 50 predetermines, with respect to each base ID to be stored in the information table 52 of the printer 50, whether a piece of information corresponding to the base ID is non-index information or index information. Further, the vendor of the printer 50 predetermines dimensionality of each index information. The vendor of the printer 50 creates the dimensionality table 26 in accordance with the contents determined as described above and prepares the management program for PC. That is, in the dimensionality table 26, each base ID is associated with a corresponding one of dimensionalities. A dimensionality “0” associated with a base ID “1.3.6.1.4.1 . . . 1.2.3.1” represents that a piece of information corresponding to the base ID is non-index information.

(Process Performed by Management Device 10; FIG. 2)

With reference to FIG. 2, a management process performed by the management device 10 will be described in detail below. For example, when a user of the management device 10 operates the operating device 12 to input an instruction for obtaining information (e.g., each MIB value) from the printer 50 into the management device 10, the control device 20 starts the management process of FIG. 2 in accordance with the management program.

At step S10, the obtaining section 30 specifies a base ID from the dimensionality table 26. Hereinafter, the base ID specified at step S10 is also referred to as a “target base ID” and a specific value of the target base ID is represented by “***”.

Then, at step S12, the determining section 36 determines whether a piece of information corresponding to the target base ID, i.e., information to be obtained, is index information. More specifically, the determining section 36 reads the dimensionality associated with the target base ID from the dimensionality table 26. When the read dimensionality is “0”, the determining section 36 makes a negative determination at step S12 (NO at step S12) and the routine moves to step S14. When the read dimensionality is “1” or greater, the determining section 36 makes a positive determination at step S12 (YES at step S12) and the routine moves to step S22. With this configuration, the management device 10 may appropriately determine whether the information to be obtained is index information.

At step S14, the obtaining section 30 prepares an OID “***.0” by combining the target base ID “***” and a default value “0”. At step S14, the obtaining section 30 prepares the OID “***.0” only. Then, at step S16, the obtaining section 30 transmits a GET request including the OID “***.0” prepared at step S14 to the printer 50.

The GET request transmitted at step S16 is a normal GET request but not a GETNEXT request or a GETBULK request. The normal GET request is implemented in SNMPv1. The GETBULK request is not implemented in SNMPv1 but implemented in SNMPv2 or SNMPv3. However, SNMPv2 and SNMPv3 offer a complicated security, and therefore, it is difficult to use SNMPv2 or SNMPv3. Accordingly, in an illustrative embodiment, the management device 10 is configured to use a normal GET request in accordance with the management program for SNMPv1. Hereinafter, unless especially specified, the GET request refers to a normal GET request.

Upon receipt of the GET request from the management device 10, the printer 50 determines whether a MIB value (hereinafter, referred to as a “target MIB value”) corresponding to the OID “***.0” included in the GET request is stored in the information table 52. When the target MIB value is present in the information table 52, the printer 50 transmits a response including the OID “***.0” and the target MIB value to the management device 10. When the target MIB value is not present in the information table 52, the printer 50 transmits a response including information “No Such” to the management device 10. The information “No Such” represents that the target MIB value is not present in the information table 52.

At step S18, the obtaining section 30 monitors a receipt of a response from the printer 50. When a predetermined time period has passed without a receipt of a response from the printer 50 since the GET request was transmitted at step S16, the obtaining section 30 makes a negative determination at step S18 (NO at step S18) and the routine moves to step S24.

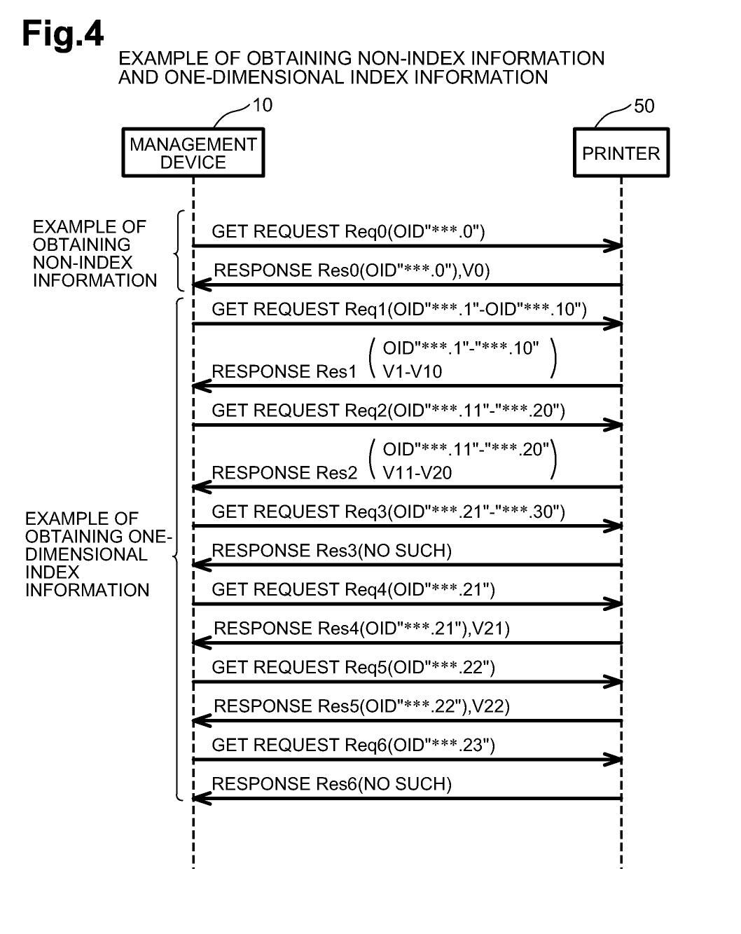

When the obtaining section 30 received the response from the printer 50 within the predetermined time period (YES at step S18), then at step S20, the obtaining section 30 stores the OID prepared at step S14 and the target MIB value included in the response in a predetermined storage area of the memory 24 in association with each other. With this configuration, the obtaining section 30 obtains non-index information from the printer 50 and stores the non-index information in the predetermined storage area. FIG. 4 illustrates an example of a process for obtaining non-index information (i.e., a MIB value “V0”) in accordance with steps S14-S20 in FIG. 2 (see a GET request Req0 and a response Res0 in FIG. 4).

When the response includes “No Such”, at step S20, the obtaining section 30 stores the OID prepared at step S14 and information representing “No Such” in the predetermined storage area in association with each other. After step S20, the routine moves to step S24.

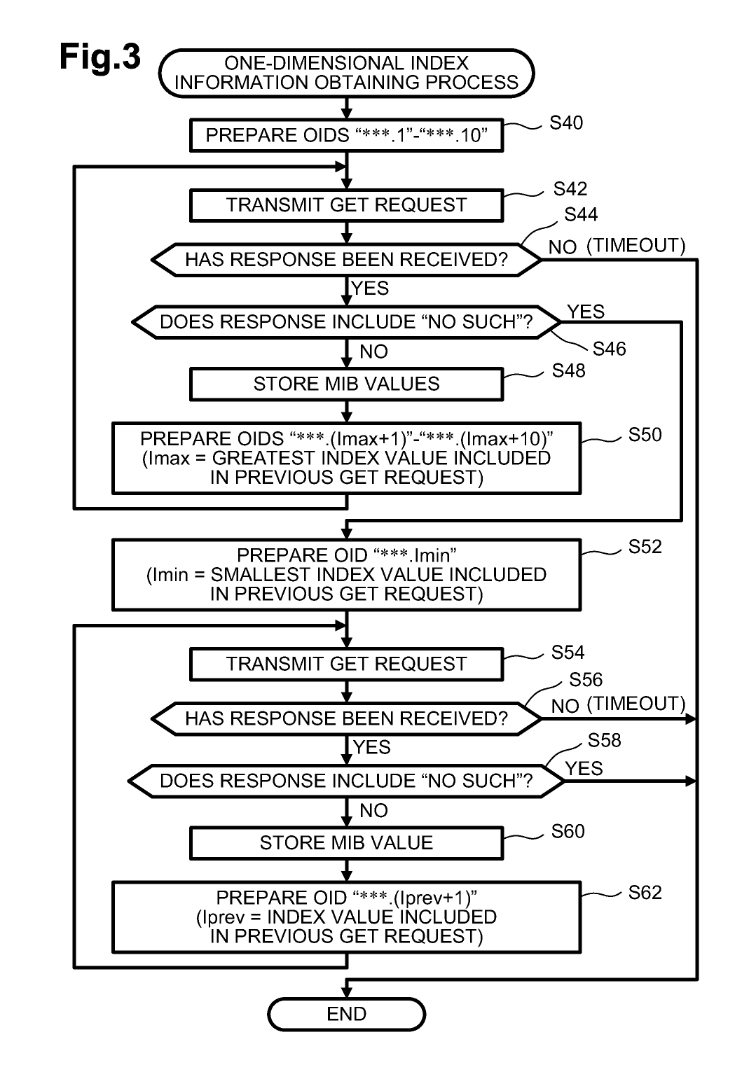

When the information to be obtained is index information (YES at step S12), at step S22, the obtaining section 30 performs an index information obtaining process (see FIGS. 3, 5, and 7). After step S22, the routine moves to step S24.

At step S24, the obtaining section 30 determines whether all of the base IDs included in the dimensionality table 26 have been specified at step S10. When all of the base IDs have not been specified yet (NO at step S24), the routine moves back to step S10 and the obtaining section 30 specifies the next target base ID included in the dimensionality table 26. When all of the base IDs included in the dimensionality table 26 have been specified (YES at step S24), the management process of FIG. 2 is ended. Although omitted from the drawings, the control device 20 displays each information stored in the predetermined storage area on the display device 14 after the management process of FIG. 2 ends. By doing so, the user is allowed to browse various information about the printer 50.

(Index Information Obtaining Process)

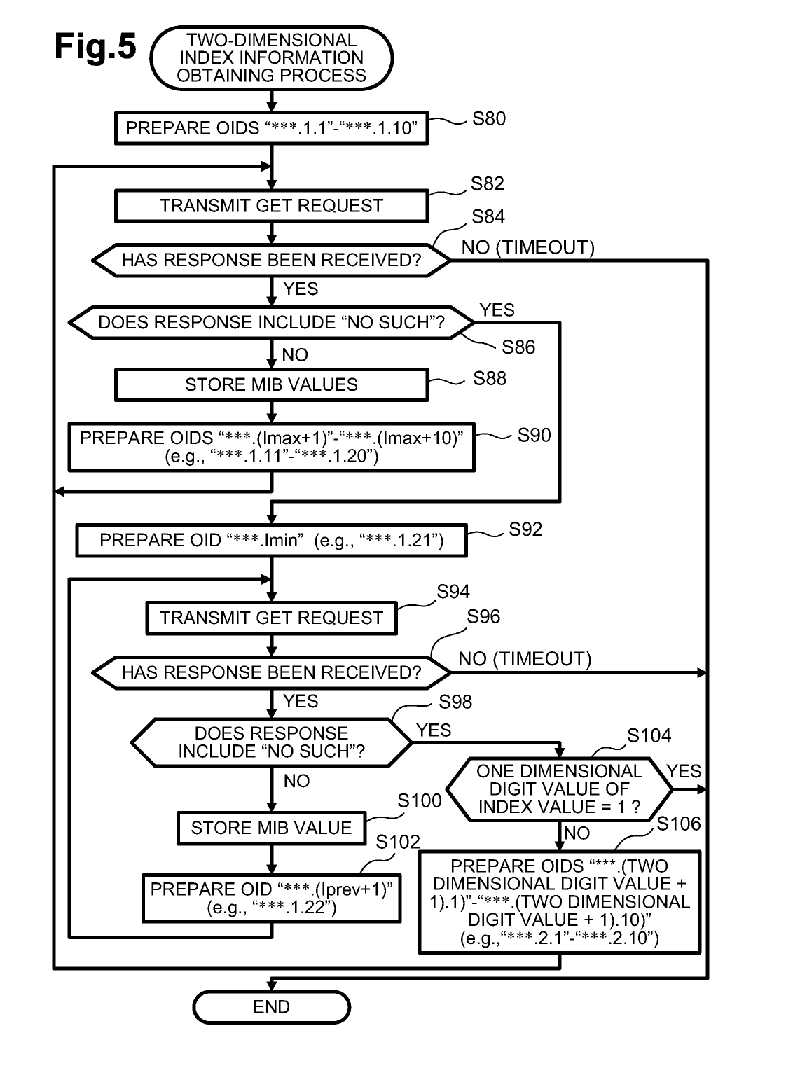

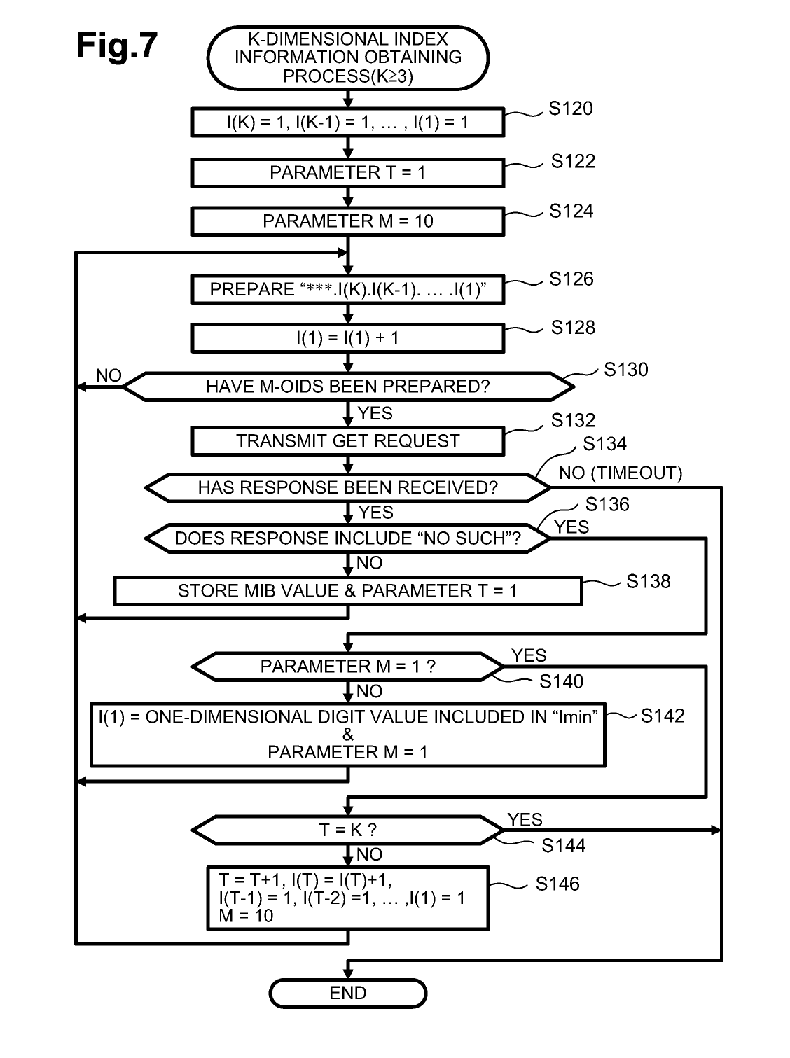

The index information obtaining process at step S22 of FIG. 2 is performed in accordance with the dimensionality associated with the target base ID. That is, when the information to be obtained is one-dimensional index information, the obtaining section 30 performs a one-dimensional index information obtaining process of FIG. 3. Similarly, when the information to be obtained is one of two-dimensional index information and K-dimensional index information (wherein “K” is an integer of 3 or greater), the obtaining section 30 performs appropriate one of a two-dimensional index information obtaining process of FIG. 5 and a K-dimensional index information obtaining process of FIG. 7.

(One-Dimensional Index Information Obtaining Process; FIG. 3)

With reference to FIG. 3, first, the one-dimensional index information obtaining process will be described in detail. At step S40, the first transmitting section 32 prepares ten OIDs “***.1“-”***.10” by combining a target base ID “***” and each of consecutive ten index values “1”-“10”. Then, at step S42, the first transmitting section 32 transmits a GET request including the ten OIDs prepared at step S40 to the printer 50. Hereinafter, a GET request (e.g., the GET request including the ten OIDs) transmitted at step S42 is referred to as a “main request”.

Upon receipt of the main request from the management device 10, the printer 50 determines whether ten MIB values (i.e., ten target MIB values) corresponding to the ten OIDs “***.1“-”***.10” included in the main request are all stored in the information table 52. When the ten target MIB values are all present in the information table 52, the printer 50 sends back a response including the ten OIDs “***.1“-”***.10” and the ten target MIB values to the management device 10. However, when one or more of the ten target MIB values are not present in the information table 52, the printer 50 transmits a response including “No Such” to the management device 10.

At step S44, the first transmitting section 32 monitors a receipt of a response from the printer 50. When a response has not been received (NO at step S44), the one-dimensional index information obtaining process of FIG. 3 is ended. When a response has been received (YES at step S44), at step S46, the first transmitting section 32 determines whether the response includes “No Such”. When the response does not include “No Such” (NO at step S46), that is, when the response includes the ten target MIB values, the routine moves to step S48.

At step S48, the first transmitting section 32 stores the ten OIDs prepared at step S40 and the ten target MIB values included in the response in the predetermined storage area of the memory 24 in association with each other. Then, at step S50, the first transmitting section 32 prepares ten OIDs “***.Imax+1”-“***.Imax+10” by combining a target base ID “***” and each of consecutive ten index values “Imax+1”-“Imax+10”. “Imax” represents the greatest index value included in the previous main request transmitted at step S42. For example, when the previous main request transmitted at step S42 includes ten index values “1”-“10”, “Imax” is “10”. In this case, at step S50, the first transmitting section 32 prepares ten OIDs “***.11“-”***.20”.

At step S42, the first transmitting section 32 transmits a main request including the ten OIDs prepared at step S50 to the printer 50. The first transmitting section 32 repeats the processing of steps S44-S50 until a negative determination is made at step S44 (NO at step S44) or a positive determination made at step S46 (YES at step S46).

When the positive determination is made at step S46 (YES at step S46), i.e., when the response includes “No Such”, at step S52, the second transmitting section 34 prepares an OID “***.Imin” by combining a target base ID “***” and an index value “Imin” “Imin” represents the smallest index value included in a previous main request transmitted at step S42. For example, the previous main request transmitted at step S42 includes ten index values “21”-“30”, “Imin” is “21”. In this case, at step S52, the second transmitting section 34 prepares an OID “***.21”.

Then, at step S54, the second transmitting section 34 transmits a GET request including the OID “***.Imin” prepared at step S52 to the printer 50. Hereinafter, a GET request transmitted at step S54 (i.e., a GET request including an OID) is referred to as a “sub-request”. Processing of steps S56-S60 is similar to the processing of steps S44-S48. After step S60, at step S62, the second transmitting section 34 prepares an OID “***.Iprev+1” by combining a target base ID “***” and an index value “Iprev+1”. “Iprev” represents an index value included in a previous sub-request transmitted at step S54. For example, the previous sub-request transmitted at step S54 includes an index value “21”, “Iprev” is “21”. In this case, at step S62, the second transmitting section 34 prepares an OID “***.22”.

Next, at step S54, the second transmitting section 34 transmits the sub-request including the OID “***.Iprev+1” prepared at step S62 to the printer 50. The second transmitting section 34 repeats the processing of steps S54-S62 until a negative determination is made at step S56 (NO at step S56) or a positive determination is made at step S58 (YES at step S58). When the positive determination is made at step S58 (i.e., when the response includes “No Such”), it means that a plurality of MIB values included in the one-dimensional index information have been all obtained. In this case, the one-dimensional index information obtaining process of FIG. 3 is ended.

(Example of Obtaining One-Dimensional Index Information; FIG. 4)

FIG. 4 illustrates the example of obtaining 22 MIB values “V1”-“V22” corresponding to 22 index values “1”-“22” in accordance with the one-dimensional index information obtaining process of FIG. 3.

First, the management device 10 transmits a main request Req1 including ten OIDs “*.1”-“***.10” to the printer 50 (see steps S40 and S42 in FIG. 3) and then receives a response Res1 including ten MIB values “V1”-“V10” from the printer 50. Then, the management device 10 transmits a main request Req2 including another ten OIDs “***.11”-“***.20” to the printer 50 (see steps S50 and S42 in FIG. 3) and then receives a response Res2 including ten MIB values “V11”-“V20” from the printer 50.

Next, the management device 10 transmits a main request Req3 including another ten OIDs “***.21“-”***.30” to the printer 50 (see steps S50 and S42 in FIG. 3). However, in this example, the printer 50 does not store MIB values corresponding to index values of “23” or greater. Therefore, the management device 10 receives a response Res3 including “No Such” from the printer 50. Thus, the management device 10 determines a positive determination at step S46 (YES at step S46) in FIG. 3 and performs the processing of step S52 and the subsequent steps.

After that, the management device 10 transmits a sub-request Req4 including an OID “***.21” to the printer 50 (see steps S52 and S54 in FIG. 3) and then receives a response Res4 including one MIB value “V21” from the printer 50. Then, the management device 10 transmits a sub-request Req5 including an OID “***.22” to the printer 50 (see steps S62 and S54 in FIG. 3) and receives an MIB value “V22” from the printer 50.

Then, the management device 10 transmits a sub-request Req6 including an OID “***.23” to the printer 50 (see steps S62 and S54 in FIG. 3). However, in this example, the printer 50 does not store the MIB value corresponding to the index value “23”. Therefore, the management device 10 receives a response Res6 including “No Such” from the printer 50. Thus, the management device 10 makes a positive determination at step S58 (YES at step S58) in FIG. 3 and the one-dimensional index information obtaining process of FIG. 3 is ended.

If a management device is configured to transmit a GET request including one OID only to the printer 50 but not to transmit a main request as described above (hereinafter, this configuration is referred to as a “first comparative configuration”), the management device needs to transmit 23 GET requests to the printer 50 to obtain 22 MIB values from the printer 50. As opposed to this, according to an illustrative embodiment, as depicted in FIG. 4, the management device 10 transmits six GET requests, e.g., the GET requests Req1-Req6, to the printer 50 to obtain 22 MIB values from the printer 50. Accordingly, the management device 10 may obtain index information more efficiently than the first comparative configuration.

When the management device 10 was able to obtain the ten MIB values “V1”-“V10” at once as a consequence of the transmission of the main request Req1, the management device 10 further transmits the main request Req2 to the printer 50. In this case, the smallest index value “11” of the index values “11”-“20” included in the main request Req2 is the next immediate value (see “Imax+1” at step S50 in FIG. 3) of the greatest index value “10” of the index value “1”-“10” included in the main request Req1. Therefore, the management device 10 may obtain 20 MIB values “V1”-“V20” corresponding to consecutive 20 index values “1”-“20” properly when the management device 10 transmits the main request Req1 and the main request Req2 sequentially.

When the management device 10 was not able to obtain ten MIB values at once (see response Res3 in FIG. 4), the management device 10 transmits the sub-requests Req4, Req5, and Req6 sequentially to the printer 50, wherein each of the sub-requests Req4, Req5, Req6 includes one OID only. The management device 10 prepares OIDs for sub-requests, respectively, such that each OID includes an index value that is greater than an index value included in the previous request and is the next consecutive value of the index value included in the previous request (see “Imin” at step S52 and “Iprev+1” at step S62 in FIG. 3). More specifically, for example, when an index value included in the sub-request Req4 is “21”, an index value included in the sub-request Req5 is “22”. That is, in an illustrative embodiment, the management device 10 sequentially prepares an OID to be included in each sub-request in ascending numeric order, e.g., “***.21”, “***.22”, and “***.23”, when the management device 10 was not able to obtain ten MIB values at once. After that, the management device 10 repeats the transmission of the sub-request to the printer 50 until the management device 10 becomes not be able to obtain a MIB value (i.e., until a positive determination is made at step S58 (YES at step S58) in FIG. 3.

If a management device does not have the above-described configuration according to an illustrative embodiment, it may be that the management device is configured to prepare each OID included in each sub-request in descending numeric order, e.g., “***.30”, “***.29”, . . . , and “***.21”, when the management device was not able to obtain ten MIB values at once (hereinafter, this configuration is referred to as a “second comparative configuration”). In this case, the management device may also obtain each MIB value “V21”, “V22”. However, the management device needs to transmit ten sub-requests to obtain the MIB values “V21” and “V22”. As opposed to this, according to an illustrative embodiment, the management device 10 transmits three sub-requests, e.g., the sub-requests Req4, Req5, Req6 in the example depicted in FIG. 4, since the printer 50 prepares each OID included in each sub-request in ascending numeric order. Therefore, the management device 10 according to an illustrative embodiment may obtain the index information more efficiently as compared with the second comparative configuration.

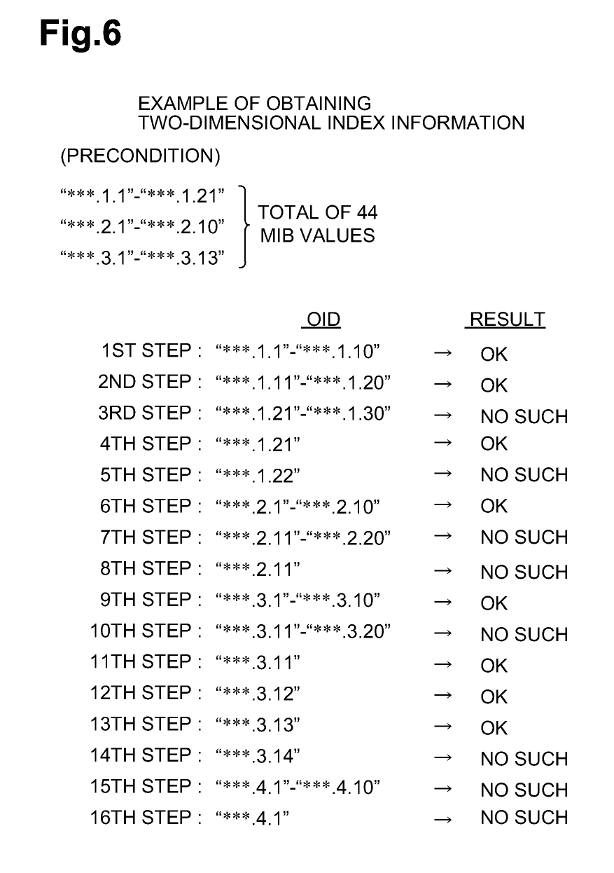

(Two-Dimensional Index Information Obtaining Process; FIGS. 5 and 6)

With reference to FIG. 5 and FIG. 6, a two-dimensional index information obtaining process will be described. FIG. 6 illustrates an example that the management device 10 obtains 44 MIB values corresponding to 44 index values in accordance with the two-dimensional index information obtaining process of FIG. 5. In FIG. 6, each step in which the management device 10 transmits a GET request including one or more OIDs to the printer 50 and receives a response from the printer 50 is represented by each ordinal number, for example, a first step and a second step. A result “OK” represents that the management device 10 receives a response including one or more MIB values. A result “No Such” represents that the management device 10 receives a response including “No Such”. It is noted that the same description is used in FIG. 8.

Processing of steps S80-S90 of FIG. 5 is similar to the processing of steps S40-S50 of FIG. 3, except that two-dimensional index values are used. That is, at step S80, the first transmitting section 32 prepares ten OIDs “***.1.1”-“***.1.10” by combining a target base ID “***” and each of consecutive ten index values “1.1”-“1.10”. Each of the consecutive ten index values includes “1” in a higher-digit (i.e., the two-dimensional digit value) and one of consecutive values “1”-“10” in a lower-digit (i.e., the one-dimensional digit value).

Then, at step S82, the first transmitting section 32 transmits a main request including the ten OIDs “***.1.1”-“***.1.10” prepared at step S80 to the printer 50. As a consequence, as depicted at a first step in FIG. 6, the first transmitting section 32 obtains ten MIB values “V1.1”-“V1.10” from the printer 50. In this case, the first transmitting section 32 makes a positive determination at step S84 (YES at step S84) and a negative determination at step S86 (NO at step S86). Then, the routine moves to step S90 through step S88.

At step S90, the first transmitting section 32 prepares ten OIDs “***.1.11”-“***.1.20”. Then, at step S82, the first transmitting section 32 transmits a main request including the ten OIDs “***.1.11”-“***.1.20” prepared at step S90 to the printer 50. As a consequence, as depicted at a second step in FIG. 6, the first transmitting section 32 obtains ten MIB values “V1.11”-“V1.20” from the printer 50.

Similarly, the first transmitting section 32 transmits another main request including ten OIDs “***.1.21”-“***.1.30” prepared at step S90 to the printer 50. As a consequence, as depicted at a 3rd step in FIG. 6, the first transmitting section 32 receives a response including “No Such” from the printer 50. In this case, the first transmitting section 32 makes positive determinations at step S84 (YES at step S84) and at step S86 (YES at step S86), respectively. Then, the routine moves to step S92.

Processing of steps S92-S 102 in FIG. 5 is similar to the processing of steps S52-S62 in FIG. 3, except that two-dimensional index values are used. That is, at step S92, the second transmitting section 34 prepares an OID “***.1.21”. Then, at step S94, the second transmitting section 34 transmits a sub-request including the OID “***.1.21” prepared at step S92 to the printer 50. As a consequence, as depicted at a fourth step in FIG. 6, the second transmitting section 34 obtains a MIB value “V1.21” from the printer 50. In this case, the second transmitting section 34 makes a positive determination at step S96 (YES at step S96) and a negative determination at step S98 (NO at step S98). Then, the routine moves to step S102 through step S100.

At step S102, the second transmitting section 34 prepares an OID “***.1.22”. Then, at step S94, the second transmitting section 34 transmits a sub-request including the OID “***.1.22” prepared at step S102 to the printer 50. As a consequence, as depicted at a fifth step in FIG. 6, the second transmitting section 34 receives a response including “No Such” from the printer 50. In this case, the second transmitting section 34 makes positive determinations at step S96 (YES at step S96) and at step S98 (YES at step S98), respectively. After that, the routine moves to step S104.

At step S104, the first transmitting section 32 determines whether the one-dimensional digit value (i.e., the lower-digit value) of the index value included in the previous sub-request transmitted at step S94 is “1”. For example, when the previous sub-request transmitted at step S94 includes an OID “***.4.1”, the one-dimensional digit value of the index value “4.1” is “1”. In this case, the first transmitting section 32 makes a positive determination at step S104 (YES at step S104), and the two-dimensional index information obtaining process of FIG. 5 is ended.

For example, when the previous sub-request transmitted at step S94 includes an OID “***.1.22”, the one-dimensional digit value of the index value “1.22” is “22”. In this case, the first transmitting section 32 makes a negative determination at step S104 (NO at step S104). Then, the routine moves to step S106.

At step S106, first, the first transmitting section 32 specifies the two-dimensional digit value “1” of the index value “1.22” included in the previous sub-request transmitted at step S94. Next, the first transmitting section 32 increments the specified two-dimensional digit value “1” by one to specify a new two-dimensional digit value “2”. Then, the first transmitting section 32 prepares ten consecutive index values “2.1”-“2.10” including the specified two-dimensional digit value “2”. After that, the first transmitting section 32 prepares ten OIDs “***.2.1”-“***.2.10” by using the ten prepared index values “2.1”-“2.10”.

Then, at step S82, the first transmitting section 32 transmits a main request including the ten OIDs “***.2.1”-“***.2.10” prepared at step S106 to the printer 50. As a consequence, as depicted at a sixth step in FIG. 6, the first transmitting section 32 obtains ten MIB values “V2.1”-“V2.10” from the printer 50. Then, the routine moves to step S90.

Processing of step 90 and subsequent steps of the two-dimensional information obtaining process are similar to the processing of the above-described steps. Therefore, processing at a seventh step and following steps in FIG. 6 are performed. When the processing of a sixteenth step in FIG. 6 is performed, the first transmitting section 32 makes a positive determination at step S104 (YES at step S104) in FIG. 5. Thus, the two-dimensional index information obtaining process (FIG. 5) is ended. That is, according to the example illustrated in FIG. 5, the management device 10 transmits 16 GET requests to the printer 50 to obtain 44 MIB values from the printer 50. Therefore, the management device 10 may obtain the two-dimensional index information efficiently.

(K-Dimensional Index Information Obtaining Process; FIGS. 7 and 8)

With reference to FIGS. 7 and 8, a K-dimensional index information obtaining process (“K” represents an integer of 3 or greater) will be described. FIG. 8 illustrates an example that the management device 10 obtains 27 MIB values corresponding to 27 three-dimensional index values in accordance with the K-dimensional index information obtaining process depicted in FIG. 7. Hereinafter, details of the flowchart of the K-dimensional index information obtaining process of FIG. 7 will be described by taking a case of obtaining three-dimensional index information as an example. The flowchart of FIG. 7 may be used when four- or more-dimensional index information is obtained.

At step S120, the first transmitting section 32 assigns “1” to each value of “I(K)”, “I(K−1)”, . . . , and “I(1)”, wherein “I(j)” represents a parameter representing a j-dimensional digit value of an index value. For example, when K=3, at step S120, the first transmitting section 32 assigns “1” to each value of “I(3)” representing a three-dimensional digit value (i.e. a higher-digit value), “I(2)” representing a two-dimensional digit value (i.e. a middle-digit value), and “I(1)” representing a one-dimensional digit value (i.e. a lower-digit value). That is, the first transmitting section 32 prepares an index value “1.1.1”.

Then, at step S122, the first transmitting section 32 assigns “1” to a parameter T. The parameter T represents a target digit to be processed. After that, at step S124, the first transmitting section 32 assigns “10” to a parameter M. The parameter M represents the number of OIDs to be included in one GET request. Next, at step S126, the first transmitting section 32 prepares an OID “***.1.1.1” by combining a base ID “***” and the index value “1.1.1” prepared at step S120.

At step S128, the first transmitting section 32 increments the current value of “I(1)” by one to assign a new value to “I(1)”. The current value of “I(1)” is “1”. Therefore, the first transmitting section 32 assigns “2” to “I(1)”, as a new value. Then, at step S130, the first transmitting section 32 determines whether “M”—OIDs have been prepared. The current value of the parameter M is “10” and only one OID “***.1.1.1” has been prepared at this point. Therefore, the first transmitting section 32 makes a negative determination at step S130 (NO at step S130). In this case, the routine moves back to step S126 and the first transmitting section 32 prepares another OID. Here, the new value “2” of “I(1)” assigned at step S128 is used. That is, the first transmitting section 32 prepares an OID “***.1.1.2”. The first transmitting section 32 prepares a total of ten OIDs “***.1.1.1”-“***.1.1.10” including ten consecutive index values “1.1.1”-“1.1.10” by repeating the processing of steps S126-S130. In this case, also, each of the ten consecutive index values “1.1.1”-“1.1.10” includes the same value “1.1” in a higher-digit (i.e., the three-dimensional digit value and the two-dimensional digit value) and one of consecutive values “1”-“10” in a lower-digit (i.e., the one-dimensional digit value). Thus, the first transmitting section 32 makes a positive determination at step S130 (YES at step S130). Then, the routine moves to step S132.

At step S132, the first transmitting section 32 transmits a main request including the ten OIDs “***.1.1.1”-“***.1.1.10” to the printer 50. Therefore, as depicted at a first step in FIG. 8, the first transmitting section 32 obtains ten MIB values “V1.1.1”-“V1.1.10” from the printer 50. In this case, the first transmitting section 32 makes a positive determination at step S134 (YES at step S134) and a negative determination at step S136 (NO at step S136). Then, the routine moves to step S126 through step S138. At step S138, the first transmitting section 32 resets the value of the parameter T to “1” when the parameter T representing the current target digit to be processed is a value other than “1” (because the value of the parameter T may be incremented at step S146).

The first transmitting section 32 prepares ten OIDs “***.1.1.11”-“***.1.1.20” by repeating the processing of steps S126-S130, and then at step S132, transmits a main request including the ten OIDs “***.1.1.11”-“***.1.1.20” to the printer 50. As a consequence, as depicted at a second step in FIG. 8, the first transmitting section 32 receives a response including “No Such” from the printer 50. In this case, the first transmitting section 32 makes positive determinations at step S134 (YES at step S134) and at step S136 (YES at step S136), respectively. Then, the routine moves to step S140.

At step S140, the second transmitting section 34 determines whether the current value of the parameter M is “1”. At this point, the current value of the parameter M is “10”. Therefore, the second transmitting section 34 makes a negative determination at step S140 (NO at step S140), and the routine moves to step S142. At step S142, the second transmitting section 34 specifies the one-dimensional digit value “11” included in Imin “1.1.11” that is the smallest index value of the ten index values “1.1.11”-“1.1.20” included in the previous main request transmitted at step S132. Then, the second transmitting section 34 replaces the current value “10” of “I(1)” with the specified value “11” to assign the specified value “11” as a new value of “I(1)”. At step S142, further, the second transmitting section 34 changes the value of the parameter M from “10” to “1”.

After step S142, the routine moves back to step S126, and the second transmitting section 34 prepares an OID. Here, the new value “11” of “I(1)” assigned at step S142 is used. That is, the second transmitting section 34 prepares an OID “***.1.1.11”. The current value of the parameter M is “1”. Therefore, the second transmitting section 34 makes a positive determination at step S130 (YES at step S130), and transmits a sub-request including the OID “***.1.1.11” at step S132. Thus, as depicted at a third step in FIG. 8, the second transmitting section 34 obtains a MIB value “V1.1.11” from the printer 50. In this case, the second transmitting section 34 makes a positive determination at step S134 (YES at step S134) and a negative determination at step S136 (NO at step S136) in FIG. 7. Then, the routine moves to step S126 through step S138.

The second transmitting section 34 repeats steps S126-S138. By doing so, the second transmitting section 34 transmits a sub-request including an OID “***.1.1.12” and thus obtains a MIB value “V1.1.12” (see a fourth step in FIG. 8). Then, the second transmitting section 34 transmits a sub-request including an OID “***.1.1.13” and thus receives a response including “No Such” (see a fifth step in FIG. 8). In this case, the second transmitting section 34 makes positive determinations at step S136 (YES at step S136) and at step S140 (YES at step S140), respectively, in FIG. 7. Then, the routine moves to step S144.

At step S144, the first transmitting section 32 determines whether the current value of the parameter T is equal to the value of “K”. At this point, the current value of the parameter T is “1” and the value of “K” is “3”. Therefore, the first transmitting section 32 makes a negative determination at step S144 (NO at step S144). Then, the routine moves to step S146.

At step S146, the first transmitting section 32 increments the current value of the parameter T by one to assign a new value to the parameter T. The current value of the parameter T is “1”. Therefore, the first transmitting section 32 assigns a new value “2” to the parameter T. After that, the first transmitting section 32 increments the current value of “I(T)” by one to assign a new value to “I(T)”. At this point, the current value of the parameter T is “2”. Therefore, the current value of “I(T)” represents the current two-dimensional digit value. The current two-dimensional digit value is “1”. Therefore, the first transmitting section 32 assigns “2” as a new two-dimensional digit value (i.e., I(T)=“2”). Then, the first transmitting section 32 assigns “1” to each value “I(T−1)”, “I(T-2)”, . . . , and “I(1)”. However, the current value of the parameter T is “2”. Thus, at this point, there is “I(T−1)” (i.e., “I(1)”) only. Accordingly, the first transmitting section 32 assigns “1” to a new one-dimensional digit value (i.e., I(T−1)=“1”). At step S146, further, the first transmitting section 32 changes the current value of the parameter M from “1” to “10”.

After step S146, the routine moves back to step S126 and the first transmitting section 32 prepares an OID “***.1.2.1” based on the values “I(T)” and “I(T−1)” assigned at step S146. Then, the first transmitting section 32 prepares ten OIDs “***.1.2.1”-“***.1.2.10” by repeating steps S126-S130 and then transmits a main request including the ten OIDs “***.1.2.1”-“***.1.2.10” to the printer 50 at step S132. Thus, as depicted at a sixth step in FIG. 8, the first transmitting section 32 receives a response including “No Such” from the printer 50 (YES at step S136 and NO at step S140 in FIG. 7).

Next, the second transmitting section 34 transmits a sub-request including an OID “***.1.2.1” to the printer 50 (step S142 and steps S126-S132 in FIG. 7), and then obtains a MIB value “V1.2.1” from the printer 50 (see a seventh step in FIG. 8; and YES at step S134 and NO at step S136 in FIG. 7). Thus, at step S138 in FIG. 7, the second transmitting section 34 changes the current value of the parameter T (i.e., the value of the parameter T incremented at step S146) from “2” to “1”.

After that, the second transmitting section 34 transmits a sub-request including an OID “***.1.2.2” and thus obtains a MIB value “V1.2.2” from the printer 50 (see an eighth step in FIG. 8). Then, the second transmitting section 34 transmits a sub-request including an OID “***.1.2.3” and thus receives a response including “No Such” from the printer 50 (see a ninth step in FIG. 8).

From then on, the similar processing is performed. As a result, the tenth step and subsequent steps in FIG. 8 are performed. When the second transmitting section 34 performs a twenty-third step in FIG. 8, the second transmitting section 34 makes a positive determination at step S144 in FIG. 7 (YES at step S144). Then, the K-dimensional index information obtaining process (see FIG. 7) is ended. That is, the management device 10 transmits 23 GET requests to the printer 50 to obtain 27 MIB values from the printer 50. Accordingly, the management device 10 may obtain the K-dimensional index information efficiently.

In FIG. 7, “K” represents an integer of 3 or greater. Nevertheless, actually, the K-dimensional index information obtaining process is available although “K” represents “1” or “2”. That is, in an illustrative embodiment, for facilitating the understanding of the technique, the management device 10 performs the one-dimensional index information obtaining process of FIG. 3 and the two-dimensional index information obtaining process of FIG. 5, instead of performing the K-dimensional index information obtaining process of FIG. 7. In other embodiments, for example, the management device 10 may obtain one-dimensional index information and two-dimensional index information in accordance with the K-dimensional index information obtaining process of FIG. 7, instead of performing FIG. 3 and FIG. 5. In this case, the same results as the results obtained by the examples depicted in FIGS. 4 and 6 may be obtained.

(Advantages of Illustrative Embodiments)

According to the illustrative embodiments, when the information to be obtained is index information, the management device 10 may obtain ten MIB values at once by transmitting a main request including ten OIDs to the printer 50 (step S42 in FIG. 3, step S82 in FIG. 5, and step S132 in FIG. 7 when the parameter M=10). Therefore, the management device 10 may obtain each MIB value efficiently. When the management device 10 was not able to obtain ten MIB values at once, the management device 10 may obtain each MIB value appropriately by transmitting one or more sub-requests each including one OID to the printer 50 sequentially (step S54 in FIG. 3, step S94 in FIG. 5, and step S132 in FIG. 7 when the parameter M=1). Therefore, as depicted in FIGS. 4, 6, and 8, the management device 10 may obtain all of a plurality of MIB values appropriately by transmitting a plurality of GET requests (e.g., 6 GET requests in FIG. 4) that are less in number than the plurality of MIB values (e.g., 22 MIB values in FIG. 4) included in index information. As described above, according to the illustrative embodiment, the management device 10 may obtain each MIB value efficiently.

In particular, according to an illustrative embodiment, the management device 10 may obtain a plurality of MIB values included in index information efficiently by performing the index information obtaining process (see FIGS. 3, 5, and 7) of step S22 in FIG. 2 although the management device 10 does not have not information about the number of MIB values included in the index information. For example, when the management device 10 obtains each MIB value in accordance with the example depicted in FIG. 4, the management device 10 may find out that the one-dimensional index information includes 22 MIB values “V1”-“V22” corresponding to 22 index values “1”-“22”. Therefore, next time, the management device 10 may transmit a GET request including 22 OIDs “***.1”-“***.22” to the printer 50 in order to obtain 22 MIB values “V1”-“V22” at once. However, as described above, for example, when the printer 50 accumulatively stores the error history, the number of MIB values (i.e., the number of index values) included in the index information may change. Therefore, it may be preferable for the management device 10 to perform the index value obtaining processes of FIGS. 3, 5, and 7 next time. By doing so, the management device 10 may appropriately obtain a MIB value corresponding to an OID newly stored in the printer 50.

(Correspondence)

The printer 50 may be an example of a “target device”. The base ID may be an example of a “target ID”. The OID may be an example of a “combined ID”. For example, in the one-dimensional index information in FIG. 1, the one-dimensional index values “1”-“22” may be an example of “a plurality of index values”. The MIB values “V1”-“V22” may be an example of “a plurality of pieces of partial target information”. The GET request Req1 and the GET request Req2 in FIG. 4 may be examples of a “first main request” and a “second main request”, respectively. In this case, the one-dimensional index values “1”-“10” may be an example of a “Ma number of consecutive index values”. The OIDs “***.1”-“***.10” may be an example of an “Ma number of combined IDs”. The MIB values “V1”-“V10” may be an example of “Ma pieces of partial target information”. Furthermore, the value “10” may be an example of values of “Ma” and “Mb”. The dimensionality in the dimensionality table 26 may be an example of “specific data”.

The GET request Req3 may be an example of the “first main request”. In this case, the one-dimensional index value “21”-“30” may be an example of the “Ma number of consecutive index values”. The OIDs “***.21”-“***.30” may be an example of the “Ma number of combined IDs”. The GET requests Req4, Req5, Req6 may be an example of “one or more (or two or more) sub-requests”. For example, in the GET request Req4, the OID “***.21” may be an example of an “N number of combined IDs of the Ma number of combined IDs” and an “N number of combined IDs for obtaining N pieces of partial target information from the target device”. The MIB value “V21” is an example of the “N pieces of partial target information”. That is the value “1” is an example of “N”.

The GET request Req4 is an example of a “first sub-request”. The GET request Req5 is an example of a “second sub-request”. In this case, the OID “***.21” is an example of a “first combined ID”, and the index value “21” is an example of a “first index value”. The OID “***.22” is an example of a “second combined ID”, and the index value “22” is an example of a “second index value”.

Although the specific illustrative embodiments of the disclosure have been described, it should be understood that the detailed description is merely illustrative and does not limit the scope of the disclosure. Variations and modifications of the illustrative embodiments are also included within the scope of claims. For example, variations described below may be included.

(Modification 1)

The target device may be not limited to printers, and may be other appropriate devices, for example, personal computers, servers, multifunction peripheral devices, copying machines, scanners, or facsimile machines may be included.

(Modification 2)

The values “Ma” and “Mb” may be not limited to “10”, and may be any value of an integer of 2 or greater (e.g., Ma=5, Mb=5). The values “Ma” and “Mb” may be different values from each other (e.g., Ma=10, Mb=8).

(Modification 3)

The value “N” may not be limited to “1”, and may be any value of an integer of 1 or greater and smaller than the value of “Ma” (e.g., N=3).

(Modification 4)

The “one or more (or two or more) sub-requests” may not be limited to a GET request but may be a GETNEXT request. The GETNEXT request is used to obtain an MIB value corresponding to a next immediate OID of an OID included in the GETNEXT request. The GETNEXT request is implemented in SNMPv1. In other embodiments, for example, in FIG. 4, the second transmitting section 34 may transmit a GETNEXT request including an OID “***.20” to the printer 50 in order to receive the response Res4, instead of the GET request including the OID “***.21”. With this configuration, also, the second transmitting section 34 may receive the response including the MIB value “V21” corresponding to the next OID “***.21” of the OID “***.20”. In an illustrative embodiment, the OID “***.20” included in the above GETNEXT request may be an example of the “N number of combined IDs for obtaining N pieces of partial target information from the target device”. The OID “***.21” may be the “N number of combined IDs of the Ma number of combined IDs”. That is, like the above-described variation, the “N number of combined IDs for obtaining N pieces of partial target information from the target device” may be different from the “N number of combined IDs of the Ma number of combined IDs”.

(Modification 5)

In other embodiments, for example, the second transmitting section 34 may not necessarily be configured to sequentially prepare each OID to be included in each sub-request in ascending numeric order, e.g., OID “***.21”, “***.22”, and “***.23”, for receiving the response Res4- Res6 in FIG. 4. That is, the second transmitting section 34 may be configured to sequentially prepare each OID to be included in each sub-request in descending numeric order, e.g., OID “***.30”, “***.29”, . . . , “***.21”. For example, each of the one or more sub-requests may include at least the N number of combined IDs.

(Modification 6)

In other embodiments, for example, in the dimensionality table 26, a flag for identifying index information or non-index information may be represented instead of the dimensionality. In this case, the determining section 36 may make a determination of step S12 in FIG. 2 based on the flag associated with the target base ID. That is, the “specific data” may be not limited to the dimensionality but may also be the flag.

(Modification 7)

In the above-described illustrative embodiments, the function of each section 30-36 may be implemented by the performance of the processing by the CPU 22 of the management device 10 in accordance with the software. In other embodiments, for example, at least a part of the function of each section 30-36 may be implemented by hardware, for example, a logical circuit.

Further, the technical elements described in the specification and the drawings exhibit technical usability alone or in various combinations, and are not limited to those in the claims at the time of the disclosure. Furthermore, the techniques described as examples in the specification or drawings may achieve a plurality of objects simultaneously, and may have technical utility by achieving any of these objects.

What is claimed is:

1. A management device comprising:
a processor; and
a memory storing computer-readable instructions that, when executed by the processor, cause the management device to perform:
determining, with reference to a table, whether target information to be obtained, from a target device, corresponding to a target ID is index information including a plurality of pieces of partial information corresponding to a plurality of index values;
transmitting a first main request including an Ma number of combined IDs to the target device after it is determined that the target information is the index information, wherein Ma is an integer of 2 or greater, and each of the Ma number of combined IDs is a combination of the target ID and one of Ma number of consecutive index values;
determining whether Ma pieces of partial target information corresponding to the Ma number of combined IDs cannot be obtained as a consequence of the transmission of the first main request; and
after it is determined that the Ma pieces of partial target information corresponding to the Ma number of combined IDs cannot be obtained as a consequence of the transmission of the first main request, transmitting a sub-request to the target device, wherein the sub-request comprises an N number of combined IDs forming a subset of the Ma number of combined IDs in the first main request, and wherein N is an integer that is 1 or greater and is smaller than Ma.

2. The management device according to claim 1,
wherein after it is determined that the Ma pieces of partial target information corresponding to the Ma number of combined IDs cannot be obtained as a consequence of the transmission of the first main request, the transmitting a sub-request to the target device is performed by sequentially transmitting two or more sub-requests to the target device;
wherein each of the two or more sub-requests comprises a combined ID; and
wherein the computer-readable instructions, when executed, further cause the management device to perform:
preparing combined IDs to be included in the two or more sub-requests, respectively, such that a first index value of a first combined ID included in a first sub-request is less than a second index value of a second combined ID included in the second sub-request to be transmitted after the first sub-request and the first index value and the second index value are consecutive.

3. The management device according to claim 2, wherein the sequentially transmitting two or more sub-requests to the target device is performed by transmitting each sub-request until not obtaining partial target information any more.

4. The management device according to claim 1, wherein the computer-readable instructions, when executed, further cause the management device to perform:
after it is determined that the Ma pieces of partial target information corresponding to the Ma number of combined IDs can be obtained as a consequence of the transmission of the first main request, transmitting to the target device a second main request including an Mb number of combined IDs, wherein Mb is an integer of 2 or greater;
wherein each of the Mb number of combined IDs is a combination of the target ID and one of the Mb number of consecutive index values; and
wherein a smallest index value of the Mb number of consecutive index values and a greatest index value of the Ma number of consecutive index values are consecutive.

5. The management device according to claim 1, wherein when the Ma number of consecutive index values are two- or more-dimensional index values, the Ma number of consecutive index values have the same value in a higher-digit of the two- or more-dimensional index values and one of consecutive values in a lower-digit of the two- or more-dimensional index values.

6. The management device according to claim 1, wherein the table lists a plurality of IDs, and each of the plurality of IDs is associated with specific data representing whether information corresponding to the respective ID is the index information; and
the determining whether the target information corresponding to the target ID is the index information is performed using particular specific data associated with the target ID.

7. The management device according to claim 6, wherein the specific data comprises dimensionality data that represents dimensionality of a plurality of index values corresponding to a plurality of pieces of partial information included in the information corresponding to the respective ID; and
the determining whether the target information corresponding to the target ID is the index information is performed using particular dimensionality data associated with the target ID.

8. A computer-readable storage medium storing computer-readable instructions that, when executed, cause a processor to perform:
determining, with reference to a table, whether target information to be obtained, from a target device, corresponding to a target ID is index information including a plurality of pieces of partial information corresponding to a plurality of index values;
transmitting a first main request including an Ma number of combined IDs to the target device after it is determined that the target information is the index information, wherein Ma is an integer of 2 or greater, and each of the Ma number of combined IDs is a combination of the target ID and one of Ma number of consecutive index values;
determining whether Ma pieces of partial target information corresponding to the Ma number of combined IDs cannot be obtained as a consequence of the transmission of the first main request; and
after it is determined that the Ma pieces of partial target information corresponding to the Ma number of combined IDs cannot be obtained as a consequence of the transmission of the first main request, transmitting a sub-request to the target device, wherein the sub-request comprises an N number of combined IDs forming a subset of the Ma number of combined IDs in the first main request, and wherein N is an integer that is 1 or greater and is smaller than Ma.

9. The computer-readable storage medium according to claim 8,
wherein after it is determined that the Ma pieces of partial target information corresponding to the Ma number of combined IDs cannot be obtained as a consequence of the transmission of the first main request, the transmitting a sub-request to the target device is performed by sequentially transmitting two or more sub-requests to the target device;
wherein each of the two or more sub-requests comprises a combined ID; and
wherein the computer-readable instructions, when executed, further cause the processor to perform:
preparing combined IDs to be included in the two or more sub-requests, respectively, such that a first index value of a first combined ID included in a first sub-request is less than a second index value of a second combined ID included in the second sub-request to be transmitted after the first sub-request and the first index value and the second index value are consecutive.

10. The computer-readable storage medium according to claim 9, wherein the sequentially transmitting two or more sub-requests to the target device is performed by transmitting each sub-request until not obtaining partial target information any more.

11. The computer-readable storage medium according to claim 8, wherein the computer-readable instructions, when executed, further cause the processor to perform:
after it is determined that the Ma pieces of partial target information corresponding to the Ma number of combined IDs can be obtained as a consequence of the transmission of the first main request, transmitting to the target device a second main request including an Mb number of combined IDs, wherein Mb is an integer of 2 or greater;
wherein each of the Mb number of combined IDs is a combination of the target ID and one of the Mb number of consecutive index values; and
wherein a smallest index value of the Mb number of consecutive index values and a greatest index value of the Ma number of consecutive index values are consecutive.

12. The computer-readable storage medium according to claim 8, wherein when the Ma number of consecutive index values are two- or more-dimensional index values, the Ma number of consecutive index values have the same value in a higher-digit of the two- or more-dimensional index values and one of consecutive values in a lower-digit of the two- or more-dimensional index values.

13. The computer-readable storage medium according to claim 8, wherein the table lists a plurality of IDs, and each of the plurality of IDs is associated with specific data representing whether information corresponding to the respective ID is the index information; and
the determining whether the target information corresponding to the target ID is the index information is performed using particular specific data associated with the target ID.

14. The computer-readable storage medium according to claim 13, wherein the specific data comprises dimensionality data that represents dimensionality of a plurality of index values corresponding to a plurality of pieces of partial information included in the information corresponding to the respective ID; and
the determining whether the target information corresponding to the target ID is the index information is performed using particular dimensionality data associated with the target ID.

15. A method comprising:
determining by a computer, with reference to a table, whether target information to be obtained, from a target device, corresponding to a target ID is index information including a plurality of pieces of partial information corresponding to a plurality of index values;
transmitting, by the computer, a first main request including an Ma number of combined IDs to the target device after it is determined that the target information is the index information, wherein Ma is an integer of 2 or greater, and each of the Ma number of combined IDs is a combination of the target ID and one of Ma number of consecutive index values;
determining, by the computer, whether Ma pieces of partial target information corresponding to the Ma number of combined IDs cannot be obtained as a consequence of the transmission of the first main request; and
after it is determined that the Ma pieces of partial target information corresponding to the Ma number of combined IDs cannot be obtained as a consequence of the transmission of the first main request, transmitting by the computer a sub-request to the target device, wherein the sub-request comprises an N number of combined IDs forming a subset of the Ma number of combined IDs in the first main request, and wherein N is an integer that is 1 or greater and is smaller than Ma.
